(19) United States
(12) Patent Application Publication
(10) Pub. No.: US 2016/0005333 A1
(43) Pub. Date: Jan. 7, 2016

(54) Real Time Car Driving Simulator

(71) Applicant: Ygdal Naouri, Jerusalem (IL)

(72) Inventor: Ygdal Naouri, Jerusalem (IL)

(21) Appl. No.: 14/753,151

(22) Filed: Jun. 29, 2015

Related U.S. Application Data
(63) Continuation of application No. PCT/US2014/045249, filed on Jul. 2, 2014.

(51) Int. Cl. G09B 19/16

(52) U.S. Cl. CPC G09B 19/167

(57) ABSTRACT

Real-time car driving simulator for providing to passengers of a vehicle the feeling they are currently driving the vehicle. The simulator includes devices combined together for providing the same functionalities of a video camera unit, an inertial measurement unit, user interface(s), a processor, and monitor(s). A passenger attempts to mimic the vehicle operator's actions while the operator is operating the vehicle and the vehicle is in motion, and an assessment of the comparison is provided to the passenger. The processor analyzes output of control components controlled by the vehicle operator provided by a vehicle control component position system and simulated control of the vehicle's movement being effected by the passenger using the user interface(s) to enable output indicative of accuracy of the simulation of the control of vehicle movement by the passenger relative to the actual control of the vehicle movement by the operator to be provided to the passenger.

### FIELD OF THE INVENTION

The present invention relates generally to in-car entertainments and/or to in-vehicle infotainments (a.k.a. IVI) and more specifically it relates to a real-time driving simulator system for providing to the passengers of a vehicle the feeling they are currently the driver of the vehicle. It relates also to the use of augmented reality (a.k.a. AR) for the learning of car driving by car passengers.

### BACKGROUND OF THE INVENTION

WO 00/43093 describes an educational and toy-simulator installed in the car in front of the child's car seat aimed at developing children's skills in the techniques of car-driving and traffic regulations as well as satisfying their need for playing. The supporter (1) places the simulator board (2) in front of the child in accordance with the structural design of the child's car seat and the car as well as with the side of the child. On the front of the simulator board (2) toy equivalents of the operators and signals of car-driving (3, . . . 14), while inside the simulator board equipment enabling their electric operation are placed. A pedal simulator (23) can be connected to the simulator board (2) or the supporter (1) simulating the pedals of the car.

### SUMMARY OF THE INVENTION

The invention generally relates to an in-car entertainment and/or to in-vehicle infotainments (a.k.a. IVI) which includes a video camera unit (a.k.a. CAM) (10), an inertial measurement unit (a.k.a. IMU) (20), one or more user interface(s) (a.k.a. UI) (30), a processing unit (a.k.a. PU) or processor (40), and one or more monitor(s) (50). Monitors 50 may be any display device of any device that includes or is capable of providing a display. Thus, a monitor includes a device that does not itself include a screen on which content is displayed but rather generates a projected display, e.g., a heads-up display system.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a rear view of an exemplifying, non-limiting embodiment of the present invention.

FIG. 2 is a functional block diagram of the present invention that provides a visual understanding of the different functionalities involved and their inter-relationships.

### DETAILED DESCRIPTION OF THE INVENTION

### A. Overview

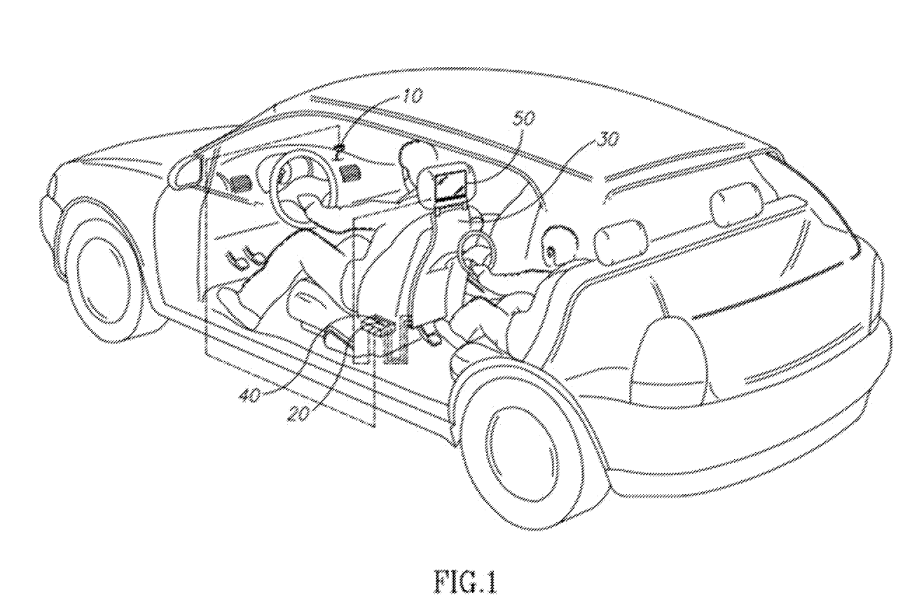

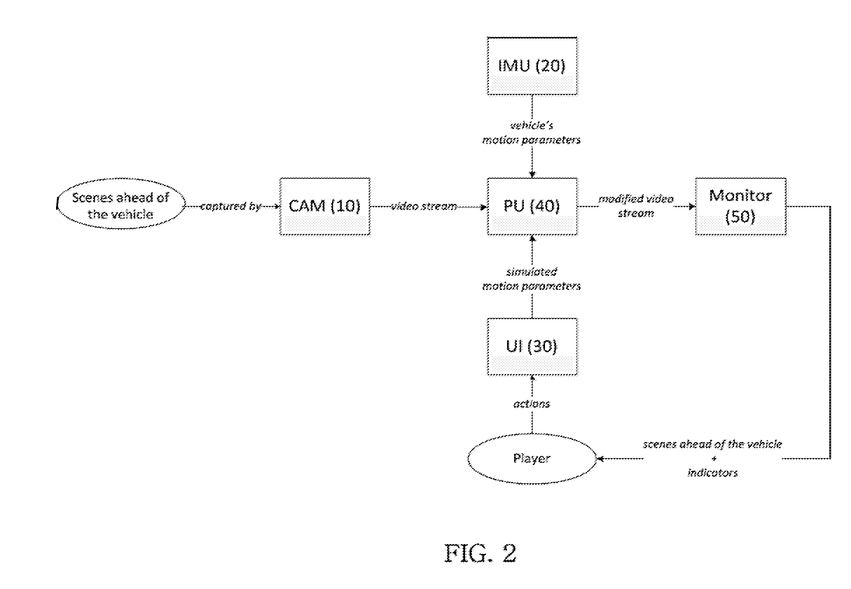

Turning now descriptively to the drawings, in which similar reference characters denote similar elements throughout the several views, FIGS. 1 and 2 illustrate a video camera unit a.k.a. CAM (10), an inertial measurement unit a.k.a. IMU (20), user interface(s) a.k.a. UI(s) (30), a processing unit a.k.a. PU (40), and monitor(s) (50).

### B. Video Camera Unit (CAM)

A video camera (CAM 10) captures scenes ahead of the vehicle and transmits the encoded motion pictures as a streaming to the processing unit (40). There, the stream made of the scenes ahead of the vehicle is processed in real time and displayed on the monitor(s) (50) which is/are located in front of the car passengers. This gives the passengers the feeling they are watching the scenes ahead of the vehicle through the windshield of the car.

The CAM (10) is a digital video camera that encodes the scenes ahead of the vehicle and delivers in a streaming manner the digitized motion pictures to the processing unit (40), via a power and data link cable (e.g., USB cable).

The angle of view shall be wide enough to cover for the driver view through the vehicle windshield and beyond it. However, the front scenes displayed to the passengers on the monitor(s) have a narrower angle of view than what is recorded by the digicam. This allows to deviate and/or to narrow the view angle and to zoom in/out the scene for producing visual effects that will guide the passenger.

The sensitivity of the video camera (10) shall preferably be high enough to allow capturing the scenes ahead of the vehicle also in the night.

The CAM (10) is preferably mounted on the dashboard or on the windshield of the vehicle, and is fixed via an adhesive fastener for instance, or via any other conventional means for attaching or fixing.

The CAM (10) can alternatively be mounted on the inner roof of the vehicle or on the back of the rearview mirror or on any other location that allows capturing the vehicle front scene with an angle view sufficiently large. For instance, the CAM (10) can be mounted at the exterior front side of the vehicle, like it is done by car manufacturers for the reverse direction camera, at the vehicle back side.

Alternatively, for reducing the routing of cabling across the vehicle compartment, the power and data link cable running between the CAM (10) and the PU (40) can be entirely or partially replaced by an independent power source for the CAM (10) like a set of batteries for instance, and/or by a wireless transmitter from the CAM (10) to the PU (40).

Alternatively, an analog video camera can be used whereas the digitalization is performed by analog to digital converters inserted on the way toward the processing unit (40). Alternatively, the video cam (10) built-in in a smartphone or a tablet can be used. An in-car smartphone holder (or tablet holder) is used for fixing the smartphone (or the tablet) onto the vehicle in a way that permits to capture the scenes ahead of the vehicle. The wireless transmission protocol built-in in the smartphone or tablet (e.g. Wi-Fi, Bluetooth, etc.) can be used to convey the scenes ahead of the vehicle to the IMU (20) (in case the IMU (20) built-in in the smartphone/tablet is not used). Otherwise, the power and wired data link cable of the smartphone or tablet can be used instead.

All the alternatives listed above to the CAM (10) and to the way to fix it to the vehicle are only examples, and are not excluding the use of any other existing possible embodiments as long as they provides the same functionality of capturing the scenes ahead of the vehicle.

### C. Inertial Measurement Unit (IMU)

An IMU (20) is used to calculate the instantaneous linear and angular acceleration/deceleration of the vehicle as well as its velocity, that is the motion parameters of the vehicle. Inertial data as used herein will therefore encompass, but is not limited to, the velocity of the vehicle which includes its speed and direction of travel, and acceleration of the vehicle.

The motion parameters are then processed by the processing unit (40) for estimating how well the driving actions taken by the vehicle driver are imitated by each of the passengers when they play through their respective user interface (30).

The motion parameters are continuously injected into the PU (40) via a power and data link cable (e.g. a USB cable) for estimating the position of the vehicle steering wheel and of the gas/brakes pedals. A gas pedal is also commonly referred to as an accelerator pedal. Generally, the steering wheel, accelerator pedal and brake pedal may be referred to as vehicle control components herein. The invention may be used with all three of these vehicle control components or a subset thereof, or possibly additional vehicle control components, e.g., a gear shift lever if a manual transmission car is to be simulated. Note that unlike in the common inertial measurement systems, the present invention does not require the knowledge of the vehicle's location, but only the instantaneous vehicle motion parameters.

Here too, for reducing the routing of cabling across the vehicle compartment, the power and data link cable running between the IMU (20) and the PU (40) can alternatively be entirely or partially replaced by an independent power source for the IMU (20) like a set of batteries for instance, and/or by a wireless transmitter from the IMU (20) to the PU (40).

Typically, a GPS (Global Positioning System) receiver is combined with a micro-controller for the retrieving of the vehicle's instantaneous motion parameters. But this is only one example since any other method can be used; such as algorithms for video motion detection applied in real time on the captured front scenes; or the combining or even the replacing of the GPS receiver with a 3-axis MEMS accelerometer, 3-axis MEMS gyroscope, 3-axis MEMS magnetometer, sensors of pressure and temperature, etc.; or by any other known method used for the same purpose.

The IMU (20) and the PU (40) can be enclosed into the same system case in which they can communicate via a system bus or any other on-board channel. This corresponds to the particular embodiment shown in FIG. 1 as an illustrated example.

Alternatively, the IMU (20) can be embedded in the built-in in-car processor provided by some car manufacturers.

Alternatively, the IMU (20) can be enclosed in a smartphone or a tablet, in which the built-in inertial and/or positioning sub-systems are combined with software applications for providing the required inertial measurement data. In such an embodiment, the CAM (10) and the IMU (20) might or might not be enclosed in the same smartphone or tablet. In case they are, the data conveyed to the PU (40) over the wired or wireless transmission channel shall combine and encode the instantaneous motion parameters together with the captured scenes ahead of the vehicle.

Alternatively, the IMU (20) can be replaced by an angle sensor fixed on the vehicle steering wheel and by position sensors fixed on the gas/brakes pedals of the vehicle.

Alternatively, the IMU (20) can be replaced by the outputs of the vehicle's built-in directional system and speedometer.

In the last two alternatives, the instantaneous positions of the steering wheel and of the gas/brakes pedals are directly measured, with no need to retrieve them from the vehicle's motion parameters.

All the alternative IMUs (20) listed above are just examples of IMU embodiments, and are not excluding the use of any other existing possible embodiments as long as they provide the same functionality of giving reliable estimations on the actions (and their intensity) currently taken by the car driver.

### D. User Interfaces(s) (UI)

Each passenger is equipped with his/her own user interface (30). It is used by the passenger for mimicking the driving actions currently taken by the car driver. For doing so, the passengers refer to the scenes ahead of the vehicle which are displayed on the monitor(s) (50) located in front of them. The passengers get visual aids (and/or audio aids) inserted into the images (and/or into the sound track) by the processing unit (40). They are referred generically as indicators as they can take any possible form.

In the preferred embodiment of the invention, the user interface is a simulator kit made of a simulator steering wheel attached to a rotary encoder, a simulator gas pedal, and a simulator brake pedal, which are both equipped with position sensors. In such an embodiment, a user interface (30) is a replication of the car driving station. This simulator kit is made of several components:

A simulator steering wheel which can be rotated by the player around its rotation axis, like the real steering wheel of a car. The current rotation angle of the simulator steering wheel relatively to an initial position is measured and encoded by a rotary encoder, and is transmitted in real time to the PU (40) over the power and data link cable (e.g. a USB cable). The angular rotation range of the simulator steering wheel may be more than 360 degrees, like for a real car's steering wheel. For safety for passengers in the rear seat, the rotation axis bar on which the steering wheel of the simulator is set can pivot toward the back side of the front seat in anticipation of a sudden deceleration of the vehicle, thus avoiding the colliding of the simulator's steering wheel with the player.

A simulator gas pedal which can be pushed/released by the player, like the real gas pedal of a car. The current position of the simulator gas pedal relatively to an initial position is measured and encoded by a position sensor, and is transmitted in real time to the PU (40) over a power and data link cable (e.g. a USB cable).

A simulator brakes pedal which can be pushed/released by the player, like the real brakes pedal of a car. The current position of the simulator brakes pedal relatively to an initial position is measured and encoded by a position sensor, and is transmitted in real time to the PU (40) over a power and data link cable (e.g. a USB cable).

The main components of the simulator kit are assembled together via a support and a fitter. The support is aimed to make the simulator's pedals and the simulator's steering wheel stand alone in some initial position, even if no one is playing with them. The fitter is aimed to adapt the position of the simulator's pedals and of the simulator's steering wheel to the tall of the player, who can be a child or an adult. The simulator's pedals and the simulator's steering wheel can be fixed on a thin booster seat or on a kind of saddle laid on the backrest of the vehicle front seat (as shown in FIG. 1). The simulator's pedals can be adjusted to the player's tall via some adjustable rigid strips, like it is done for the rider's legs over a horse saddle. The simulator's steering wheel can be adjusted to the player's tall by a telescopic bar fixed with pins.

Several alternative embodiments of the support and of the fitters do exist:

1. The simulator pedals and the simulator steering wheel can be fixed on a thin booster seat or on a kind of saddle laid on the vehicle back seat. As before, the simulator pedals can be adjusted to the player's tall via adjustable rigid strips and the steering wheel can be adjusted to the player's tall by a telescopic bar fixed with pins.

2. The supporter can be made of a box laid on the vehicle's back floor, on which the simulator pedals and simulator steering wheel are fixed via fixing bars. The adjuster in this case is made of the box lid which can be raised/lowered via pluggable pins for matching the player's tall. The rotary bar axe on which the simulator steering wheel is fixed can pivot back and forth in the aim to be adapted to the player's hands length. The bar position is then fixed via pluggable pins or any other adjustable aim.

3. The simulator kit (30) can also be provisioned and embedded within the back seats, in a non-removable manner.

As before, for reducing the routing of cabling across the vehicle compartment, the power and data link cable running between the UI (30) and the PU (40) can be alternatively entirely or partially replaced by an independent power source for the UI (30) like a set of batteries for instance, and/or by a wireless transmitter from the UI (30) to the PU (40).

Alternatively, the user interface (30) can be made of one or several joysticks by which the player enters the driving actions he/she desires to take for mimicking the car driver, like vehicle's direction change and acceleration/deceleration.

Alternatively, the user interface can be replaced by a smartphone or a tablet held by the passenger. He/she has to turn, tilt, and/or move the smartphone or the tablet he/she holds to mimic the car driving actions.

It can be for instance that turning the smartphone or the tablet to the right as if it was a steering wheel is interpreted as if the passenger has turned a simulator steering wheel to the right, and vice versa for the left. Alternatively to the use of turning actions, tilting the smartphone or the tablet to the right around its vertical axis can be interpreted as if the passenger has turned a simulator steering wheel to the right, and vice versa for the left. Alternatively, moving in translation the smartphone or the tablet to the right can be interpreted as if the passenger has turned a simulator steering wheel to the right, and vice versa for the left. Any combination of the mentioned alternatives can be used in such an embodiment of the user interface.

Similarly, tilting the smartphone or the tablet forward around its horizontal axis can interpreted as if the passenger has pressed the gas pedal or released the brake pedal, and that tilting it backward is interpreted as if he/she has released the gas pedal or pressed the brake pedal. Alternatively to tilting actions, moving the smartphone in the forward direction is interpreted as if the passenger has pressed the gas pedal or released the brake pedal, and moving it in the rear direction is interpreted as if he/she has released the gas pedal or pressed the brake pedal.

In such an embodiment, the smartphone or tablet used for a user interface (30) may or may not be the same smartphone or tablet used for capturing the scenes ahead of the vehicle—the two options are possible. In such a case, the IMU (20) is preferably embedded in the smartphone or tablet which is used for capturing the scenes ahead of the vehicle, but it may also be embedded (and thus replicated) in the smartphone(s) or tablet(s) used for the user interface(s).

In such an embodiment, the UI (30) may or may not be enclosed in the same smartphone or tablet together with the CAM (10) and/or the IMU (20). In case they are, the data conveyed to the PU (40) over the wired or wireless transmission channel shall combine and encode the user's playing actions together with the scenes ahead of the vehicle and/or with the instantaneous motion parameters.

All the alternative UIs (30) listed above are just examples of UI embodiments, and are not excluding the use of any other existing possible embodiments as long as they provide the same functionality of entering into the system the player's actions he/she takes to mimic the car driver's driving actions.

For conciseness and for gaining in clarity when it comes to describe the object of the invention, the present document refers to the preferred embodiment of the user interface (30) (that is the simulator kit), but it does not exclude any other alternative user interface (30) mentioned above. Moreover, any other kind of existing user interface (30) can be used for this purpose as long as it provides a way for the user to enter directional and acceleration/deceleration commands as inputs into the system.

### E. Processing Unit (PU)

The processing unit (40) estimates the positions of the vehicle's steering wheel and of its gas/brakes pedals that are required to produce the vehicle motion parameters measured by the IMU (20). For each passenger separately, the PU (40) compares the estimated positions with the positions of his/her simulator's steering wheel, simulator gas pedal and simulator brake pedal in order to determine instantaneously how well each passenger succeeds to mimic the car driver.

The processing unit (40) shall preferably insert indicators which may be some visual aids in the images sent to the monitors (50) (and/or some audio aids in the sound track played by the monitors' speakers) in order to notify the player whether or not some driving action shall be taken. For instance if the player should increase the pressure he/she is currently applying on the simulator's gas pedal, the image can be shifted down and/or zoomed out, and/or a dial indicator added over the image can be shifted down. These are just few examples of all the possible indicators that may be inserted onto or beside the scenes ahead of the vehicle which are displayed by the monitor (50).

As being a generic term, the indicators represent in fact any effects and technics which are used to produce an augmented reality (AR) based upon real life imagery. It may for instance include the processing of the images in a way to produce an animation or a cartoon which is combined with reality's scenes.

The PU (40) typically consists of a micro-processor or of any device which has processing abilities and/or computing abilities and which can perform image processing tasks over a streaming video input. By such, a micro-controller sub-system, or any programmable device, or a dedicated silicon chip, or any combination between them can be used instead of a micro-processor.

The PU (40) performs the following tasks:

1. It estimates the position of the vehicle's steering wheel and of its gas/brakes pedals that are required at every instant to achieve the vehicle's motion parameters which are received from the IMU (20). The angular velocity is converted in a steering wheel position according to a predefined conversion scale. Similarly, the linear acceleration is converted in a position of the gas pedal. A small deceleration is converted in the release of the pressure on the gas pedal. A big deceleration is converted in a brakes pedal position according to a predefined conversion scale too.

2. It compares the positions of the vehicle's steering wheel and its gas/brakes pedals which were estimated in step 1, with the positions of the simulator's steering wheel and its gas/brakes pedals which are received from the simulator kits (30).

3. It inserts indicators to the streaming images received from the CAM (10).

4. It delivers the streaming images processed in step 3 to the monitors (50) over the power and data link cable.

The indicators for the vehicle's direction are inserted for each player separately, in proportion to the algebraic delta measured between the position of the vehicle's steering wheel and the position of the simulator's steering wheel of a passenger. If a player should turn the simulator steering wheel to the left to mimic the car driver, the image can for instance be shifted right to make the player feel that the vehicle derives to the right—until he/she takes the appropriate action. Inversely, if the player should turn the simulator steering wheel to the right to mimic the car driver, the image can for instance be shifted left to make the player feel that the vehicle derives to the left—until he/she takes the appropriate action.

Similarly, the indicators for the acceleration/deceleration of the vehicle are inserted for each player separately, in proportion to the algebraic delta measured between the position of the vehicle's gas/brakes pedals and the position of the simulator's gas/brakes pedals. If the player should increase the pressure he/she is applying on the simulator gas pedal, the image can for instance be shifted down and/or zoomed out, to make the player feel that the vehicle is slowing down—until he/she takes the appropriate action. Inversely, if to mimic the car driver the player should decrease the pressure he/she is applying on the simulator gas pedal and then start applying a pressure on the brakes pedal, the image can be for instance shifted up and/or zoomed in, to make the player feel that the vehicle is slowing down—until he/she takes the appropriate action.

In addition to (or instead of) shifting the image left/right and zooming the image up/down, indicators in the form of dials can be added onto or beside the streaming video.

The intensity of the indicators can also be proportional to the time that the delta between the positions of the vehicle's driving elements (the steering wheel and/or gas/brakes pedals) and the corresponding element in the simulator kit has lasted.

In general, any function of the delta over the time can be used as an input to the indicators applying function. Filtering applied over the delta variations can help tuning the reactivity (a.k.a. the nervousness) of the guiding system, taking in account that a too ‘nervous’ guiding system can be annoying to the players.

As related to items 1 and 2 above, instead of estimating the position of the vehicle's steering wheel and gas/brakes pedals, the PU (40) can alternatively estimate the simulated motion parameters induced by the positions of the simulator's steering wheel and gas/brakes pedals. Then the delta between the measured and estimated motions parameters can be used as the input to the indicators applying function.

The PU (40) and the IMU (20) can be enclosed within a shared system case, which is attached by a fastener under the driver's seat (or the front passenger's seat). This corresponds to the embodiment shown in FIG. 1 as an illustrated example.

Alternatively, the PU (40) can be the built-in processor embedded in-car by some car manufacturers for running any other task.

Alternatively, the PU (40) can be embedded in a smartphone or a tablet. In such an embodiment, the PU (40) may or may not be enclosed in the same smartphone or tablet together with the CAM (10) and/or the IMU (20) and/or the UI (30). All the combinations are possible. In case they are, the data conveyed to the PU (40) within the smartphone or the tablet shall combine and encode together the scenes ahead of the vehicle and/or the instantaneous motion parameters and/or the user's playing actions, respectively.

Alternatively, the PU (40) can be run in a remote server located in a data center far away from the vehicle, and which is accessed through wireless networks such as the cellular phone network.

The PU (40) can be powered from the car battery via a power cable (typically a 12V power cable). It can be turned ON when the car get started and turned OFF when the car is shut down.

The PU (40) unit can alternatively be powered by any independent power source like a set of batteries for instance.

The PU (40) is connected to all the other simulator units via power and data link cables. It was assumed that the PU (40) unit is powering the other units through power and data link cables, but it can be any other unit of the present invention that powers the other units, or any combination of thereof.

Alternatively, each power and data link cable can be entirely or partially replaced by wireless transmitters and/or receivers to reduce the routing of cabling across the vehicle compartment. Any combination of wired and wireless connections can be used between the PU (40) and the other units of the simulator.

The PU (40) embodiments listed above are just examples, and are not excluding the use of any other existing possible embodiment as long as it provides the same basic functionality of processing the streaming video of the scenes ahead of the vehicle (and optionally generating a sound track and inserting indicators) according to the delta between the actions taken by the car driver and those taken by the player.

The visual and/or audio artifacts listed above and referred as indicators are only examples of the indicators that may be applied by the PU (40) on the input streaming video and/or its sound track, and are not excluding the use of any other existing possible indicators as long as they provide the same basic functionality of guiding the player. In general, many other indicators and artifices can be envisaged to be applied on the input streaming video and/or its sound track for making the players understand an action has to be taken for mimic the car driver. The indicators can be of any kind as long as they define an understandable guiding system to the players.

In addition, many other visual and/or audio items can be provided by the PU (40) as necessary, like for instance, configuration and setup screens, display of good/bad points accumulated by a player, etc. or any other item generally present in simulators and video games.

### F. Monitor[s]

A monitor (50) is placed in front of each passenger, for rear passengers preferably at the rear side of the front seats. It displays the scenes ahead of the vehicle which are constantly captured by the CAM (10), and to which indicators and artifacts were added by the PU (40) in real time.

Like in many today's cars, each rear passenger can be equipped with his/her own LCD monitor that is inserted on the rear side of the driver's seat and of the front passenger's seat.

The streaming video captured by the CAM (10) is processed by the PU (40) in a different manner for each passenger, according to the driving actions taken by him/her with his own user interface (30). It results that the images displayed by two monitors (50) can be slightly different, as per the different visual aids and artifacts added by the PU (40) for each player.

Each monitor (50) is connected to the PU (40) via a power and data link cable.

Alternatively, for reducing the routing of cabling across the vehicle compartment, the power and data link cable running between a monitor (50) and the PU (40) can be entirely or partially replaced by an independent power source for the monitor (50) like a set of batteries for instance, and/or by a wireless transmitter/receiver between the monitor (50) to the PU (40).

The monitor (50) can alternatively be connected to a DVD/USB player like it may exist in some of today's cars. In such a case, a switch can be used to commute between the two possible input streams, either from the DVD/USB or from the PU (40).

Alternatively, the monitor (50) can be embedded in a smartphone or a tablet. In such an embodiment, the monitor (50) may or may not be enclosed in the same smartphone or tablet together with the CAM (10) and/or the IMU (20) and/or the UI (30) and/or the PU (40). All the combinations are possible. In case it is, the data conveyed to the monitor (50) within the smartphone or the tablet shall combine and encode together the scenes ahead of the vehicle and/or the instantaneous motion parameters and/or the user's playing actions and/or the indicators and other artifacts added by PU (40), respectively.

In case the monitor (50) is not embedded in the same smartphone or tablet than the UI (30), an in-car smartphone or tablet holder is preferably used to hold it in a fixed position w.r.t. the player.

### G. Connections of Main Elements and Sub-Elements of Invention

All the elements are connected to the PU (40) via their power and data link cables.

Alternatively, the connecting channels can be made wireless or embedded within the same device (e.g. a smartphone or a tablet), and each element can have its own independent power source like a set of batteries for instance.

### H. Alternative Embodiments of Invention

What has been described and illustrated herein are the preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

A variant of the present invention can use a pre-recorded video of the vehicle front scenes captured at another driving session by the same or by another vehicle. The car passengers will then have to mimic the pre-recorded driving session while being driven for another trip. This may be useful for instance when the present trip does not offer interesting front scenes.

In addition to the indicators listed before, the PU (40) can insert into the image front scenes the rear scenes of the vehicle, like would do a rear view mirror. The rear scenes can be captured by another video cam directed toward the rear of the vehicle, and connected to the PU (40) via one of the means listed for the front view video cam.

Any of the foregoing embodiments are innovative in that it provides a real time car driving simulator that entertains the passengers of a vehicle, while at the same time, keeps them connected with the surrounding landscapes. Also, the embodiments provide a real time car driving simulator that gives passengers the pleasant feeling that they are driving the vehicle at the driver's seat. Even further, the embodiments provide a real time car driving simulator that prevents nausea to the passengers of a car. An embodiment is also advantageous because it provides a real time car driving simulator for the learning of car driving while not being currently the driver of the vehicle, as a complement (or in advance) to car driving lessons. The simulator is based on an augmented reality for providing to the user an experience very close to real life road conditions.

In another embodiment of the invention, it is possible that the processing unit (40), the IMU (20), the CAM (10), the monitor (50) and possibly also the user interface (30) are part of a vehicle when manufactured. One or more of these components, or possibly even all of these components, may be built into the vehicle by the manufacturer. Thus, a simulator in accordance with the invention may be a feature of a vehicle when sold. In addition, the invention could be a computer program resident at the PU (40) to coordinate receipt of and process input from the CAM (10), the IMU (20) and the user interface (30), and generate output for the monitor (50). Such a computer program could be downloaded into the PU (40).

Other objects and advantages of the present invention are or will become obvious to the reader in view of the disclosure herein and it is intended that these objects and advantages are within the scope of the present invention. To accomplish the above and related objects, this invention may be embodied in the form illustrated in the accompanying drawings, attention being called to the fact, however, that the drawings are illustrative only, and that changes may be made in the specific construction illustrated and described within the scope of this application.

1. A driving simulator for a moving vehicle having an operator seat occupied by an operator of the vehicle who controls movement of the vehicle and at least one passenger seat occupied by a person other than the operator of the vehicle at the same time that the operator of the vehicle occupies the operator seat, comprising:
a processor;
a video camera arranged on the vehicle and that provides videos of scenes in front of the vehicle to said processor;
a monitor coupled to said processor, said monitor being configured to display videos provided by said video camera when said monitor is in a location visible to the person in the at least one passenger seat;
a user interface accessible by the person when in the at least one passenger seat and coupled to said processor, said user interface being configured to enable the person in the at least one passenger seat to simulate control of movement of the vehicle based on the videos being displayed on said monitor without actually controlling movement of the vehicle; and
a vehicle control component position system arranged on the vehicle and coupled to said processor, said vehicle control component position system providing output related to position of control components that are controlled by the operator of the vehicle,
said processor being configured to analyze the output of the control components that are controlled by the operator of the vehicle provided by said vehicle control component position system and the simulated control of the movement of the vehicle being effected by the person in the at least one passenger seat using said user interface to enable output indicative of accuracy of the simulation of the control of the movement of the vehicle by the person in the at least one passenger seat relative to the actual control of the movement of the vehicle by the operator to be provided to the person in the at least one passenger seat.

2. The simulator of claim 1, wherein said vehicle control component position system comprises an inertial measurement unit that obtains inertial data about the vehicle, the position of the control components that are controlled by the operator of the vehicle being derived or estimated from the inertial data by said processor, the inertial data including one or more of velocity of the vehicle and acceleration of the vehicle.

3. The simulator of claim 2, wherein said processor analyzes the position of the control components that are controlled by the operator of the vehicle derived or estimated by said processor based on the output provided by said vehicle control component position system and the simulated control of the movement of the vehicle being effected by said user interface by estimating positions of a steering wheel, an accelerator pedal and a brake pedal of the vehicle from the inertial data obtained from said inertial measurement unit and comparing the estimated positions to the positions of a simulated steering wheel, a simulated accelerator pedal and a simulated brake pedal being controlled by the person in the at least one passenger seat using said user interface.

4. The simulator of claim 1, wherein said vehicle control component position system comprises position sensors associated with the control components that are controlled by the operator of the vehicle that directly provide position of the control components that are controlled by the operator of the vehicle to said processor, the control components that are controlled by the operator of the vehicle including one or more of a steering wheel of the vehicle, an accelerator pedal of the vehicle and a brake pedal of the vehicle.

5. The simulator of claim 4, wherein said processor analyzes the position of the control components that are controlled by the operator of the vehicle provided by said vehicle control component position system and the simulated control of the movement of the vehicle being effected by the person in the at least one passenger seat using said user interface by estimating simulated positions of a steering wheel, an accelerator pedal and a brake pedal controlled by the person in the at least one passenger seat using said user interface and comparing the estimated simulated positions to the positions of the steering wheel, the accelerator pedal and the brake pedal provided by said vehicle control component position system.

6. The simulator of claim 5, wherein said processor is configured to insert visual and/or audio indicators for the person in the at least one passenger seat in the videos being displayed on said monitor based on the comparison of the estimated simulated positions of the steering wheel, the accelerator pedal and the brake pedal to the positions of the steering wheel, the accelerator pedal and the brake pedal provided by said vehicle control component position system.

7. The simulator of claim 1, wherein said vehicle control component position system and said processor are housed in a common housing on the vehicle.

8. The simulator of claim 1, wherein said vehicle control component position system is wirelessly coupled to said processor.

9. The simulator of claim 1, wherein said processor is apart from the vehicle.

10. The simulator of claim 1, further comprising:
at least one additional monitor coupled to said processor, each of said at least one additional monitor being configured to display the videos provided by said video camera when in a location visible to a person in at least one other passenger seat; and
at least one additional user interface accessible by a person in each of the at least one other passenger seat, said at least one user interface being configured to enable the person in the at least one other passenger seat to simulate control of movement of the vehicle based on the videos being displayed on a respective one of said at least one additional monitor,
said processor being configured to analyze the position of the control components that are controlled by the operator of the vehicle provided by said vehicle control component position system and the simulated control of the movement of the vehicle being effected by the person in the at least one other passenger seat using said at least one additional user interface to enable output indicative of accuracy of the simulation of the control of the movement of the vehicle by each person in the at least one other passenger seat to be provided to that person.

11. The simulator of claim 1, wherein said processor is configured to insert visual and/or audio indicators in the videos being displayed on said monitor.

12. The simulator of claim 1, wherein said processor is configured to insert visual and/or audio indicators in the videos being displayed on said monitor based on accuracy of the simulation of the control of the movement of the vehicle by the person in the at least one passenger seat.

13. The simulator of claim 1, wherein said processor is configured to insert visual and/or audio indicators in the videos being displayed on said monitor based on content of the videos.

14. The simulator of claim 1, wherein said user interface comprises a rotary encoder, a steering wheel attached to the rotary encoder, a position sensor-equipped accelerator pedal, and a position sensor-equipped brake pedal.

15. The simulator of claim 1, wherein said user interface comprises a joystick.

16. The simulator of claim 1, wherein said user interface comprises a portable communications device wirelessly coupled to said processor.

17. The simulator of claim 16, wherein said video camera is embodied in an additional portable communications device and is wirelessly coupled to said processor.

18. The simulator of claim 1, wherein said video camera is embodied in a portable communications device and is wirelessly coupled to said processor.

19. The simulator of claim 1, wherein said user interface enables the person in the at least one passenger seat to simulate control of movement of the vehicle by converting directional and acceleration/deceleration commands entered via use of said user interface into simulated control of movement of the vehicle without actually controlling movement of the vehicle.

20. The simulator of claim 1, wherein said processor does not consider location of the vehicle when analyzing the output of said vehicle control component position system related to the position of the control components that are controlled by the operator of the vehicle and the simulated control of the movement of the vehicle being effected by the person in the at least one passenger seat using said user interface.
